(19) United States
(12) Patent Application Publication
(10) Pub. No.: US 2023/0184560 A1
(43) Pub. Date: Jun. 15, 2023

(54) VISUAL INTERFACE DISPLAY METHOD AND APPARATUS, ELECTRONIC DEVICE, AND STORAGE MEDIUM

(71) Applicant: GUANGZHOU WERIDE TECHNOLOGY LIMITED COMPANY, Guangzhou (CN)

(72) Inventors: Chunhui CHE, Gaungzhou (CN); Chao PAN, Gaungzhou (CN); Guangqing CHEN, Gaungzhou (CN); Yankai OU, Guangzhou (CN); Hua ZHONG, Gaungzhou (CN); Xu HAN, Gaungzhou (CN)

(73) Assignee: GUANGZHOU WERIDE TECHNOLOGY LIMITED COMPANY, Guangzhou (CN)

(21) Appl. No.: 17/925,121

(22) PCT Filed: Dec. 29, 2020
(86) PCT No.: PCT/CN2020/140611

§ 371 Date: Nov. 14, 2022

(30) Foreign Application Priority Data
May 14, 2020 (CN) 202010408219.0

(51) Int. Cl. G01C 21/36; G01C 21/34

(52) U.S. Cl. CPC G01C 21/3638; G01C 21/3694; G01C 21/3492; G01C 21/3697

(57) ABSTRACT

Provided are a visual interface display method and apparatus, an electronic device, and a storage medium. The display method includes determining that a target vehicle executes a driving task (S101); displaying a map within a preset range according to the real-time position of the target vehicle (S102); displaying a first object model for a first object detected by the target vehicle on the map; and displaying a second object model including at least point cloud data for a detected non-first object (S103).

### CROSS-REFERENCE TO RELATED APPLICATION(S)

This is a national stage application filed under 37 U.S.C. 371 based on International Patent Application No. PCT/CN2020/140611, filed on Dec. 29, 2020, which claims priority to Chinese Patent Application No. 202010408219.0 filed with the China National Intellectual Property Administration (CNIPA) on May 14, 2020, the disclosure of which is incorporated herein by reference in its entirety.

### TECHNICAL FIELD

The present application relates to the field of self-driving technology, for example, a visual interface display method and apparatus, an electronic device, and a storage medium.

### BACKGROUND

With the development of science and technology, automotive self-driving technology is in a critical period of the vigorous development. To improve the user experience, a driving environment is visualized to display the environment around a car in real time.

### SUMMARY

The present application provides a visual interface display method and apparatus, an electronic device, and a storage medium to solve the problem that in the related art, the inaccurate classification of an object causes a wrong model or even no model to be displayed for an inaccurately classified object on a visual interface and the user experience to be reduced.

In a first aspect, some embodiments of the present application provide a visual interface display method. The method includes the steps below.

It is determined that a target vehicle executes a driving task.

A map within a preset range is displayed according to the real-time position of the target vehicle.

An object model is displayed on the map. A first object model is displayed for a first object detected by the target vehicle. A second object model including at least point cloud data is displayed for a non-first object detected by the target vehicle.

Optionally, the method also includes the step below.

A vehicle model is displayed for the target vehicle on the map according to the real-time position of the target vehicle.

Optionally, the first object model is displayed for the first object detected by the target vehicle as follows.

The environment information detected by the target vehicle is acquired when the driving task is executed.

A position and a type of the first object in the environment information are recognized.

The first object model matching the first object is acquired according to the type of the first object.

The first object model is displayed according to the position of the first object.

Optionally, the second object model including at least the point cloud data is displayed for the non-first object detected by the target vehicle as follows.

The environment information detected by the target vehicle is acquired when the driving task is executed.

A position and a type of a second object in the environment information are recognized.

The point cloud data of the second object is extracted from the environment information.

The second object model including at least the point cloud data is displayed according to the position of the second object.

Optionally, the method further includes the step below.

Task progress information of the driving task executed by the target vehicle is displayed. The task progress information includes at least one of a progress bar, a driven distance, or a driven time.

Optionally, the method further includes the steps below.

A driving route generated for the target vehicle is displayed on the map; and/or traffic light information is displayed, where the traffic light information is used to indicate the state of a traffic light detected by the target vehicle; and/or navigation information generated for the target vehicle is displayed.

Optionally, the method further includes the step below.

The first object model is highlighted when the first object model is on the driving route.

Optionally, the navigation information generated for the target vehicle is displayed as follows.

The speed of the target vehicle is displayed when the target vehicle executes the driving task; and/or the distance from the target vehicle to a destination is displayed.

In a second aspect, some embodiments of the present application provide a visual interface display apparatus. The apparatus includes a driving task determination module, a map display module, and an object model display module.

The driving task determination module is configured to determine that the target vehicle executes the driving task.

The map display module is configured to display the map within the preset range according to the real-time position of the target vehicle.

The object model display module is configured to display the object model on the map, where the object model display module is further configured to display the first object model for the first object detected by the target vehicle and display the second object model including at least the point cloud data for the non-first object detected by the target vehicle.

In a third aspect, some embodiments of the present application provide an electronic device. The electronic device includes one or more processors and a memory configured to store one or more programs.

When executing the one or more programs, the one or more processors perform the visual interface display method according to some embodiments of the present application.

In a fourth aspect, some embodiments of the present application provide a computer-readable storage medium. The storage medium stores a computer program. When executing the computer program, a processor performs the visual interface display method according to some embodiments of the present application.

When it is determined that the target vehicle executes the driving task, the map within the preset range is displayed according to the real-time position of the target vehicle, and the object model is displayed on the map. A first object model is displayed for a first object detected by the target vehicle so that a first object model can be displayed for the accurately classified first object. A second object model including at least the point cloud data is displayed for a non-first object detected by the target vehicle so that the second object model can be displayed for the inaccurately classified or unclassifiable non-first object. Accordingly, models may be displayed for the first object and the non-first object detected by the target vehicle, and the second object model including at least the point cloud data may be displayed for the non-first object without classifying the non-first object. In this manner, the data volume of model rendering of the non-first object is reduced, and it is not even necessary to render a model for the non-first object, so that while a model is displayed for a detected object, the speed of model rendering is improved. Thus, the user experience is improved.

### BRIEF DESCRIPTION OF DRAWINGS

FIG. 1 is a flowchart of a visual interface display method according to some embodiments of the present application.

FIG. 2 is a flowchart of a visual interface display method according to some embodiments of the present application.

FIG. 3 is a view of a visual interface according to some embodiments of the present application.

FIG. 4 is a flowchart of a visual interface display method according to some embodiments of the present application.

FIG. 5 is a diagram illustrating the structure of a visual interface display apparatus according to some embodiments of the present application.

FIG. 6 is a diagram illustrating the structure of an electronic device according to some embodiments of the present application.

### DETAILED DESCRIPTION

The present application is further described in detail hereinafter in conjunction with the drawings and embodiments. It is to be understood that the embodiments described herein are merely intended to illustrate and not to limit the present application. Additionally, it is to be noted that to facilitate description, only part, not all, of structures related to the present application are illustrated in the drawings.

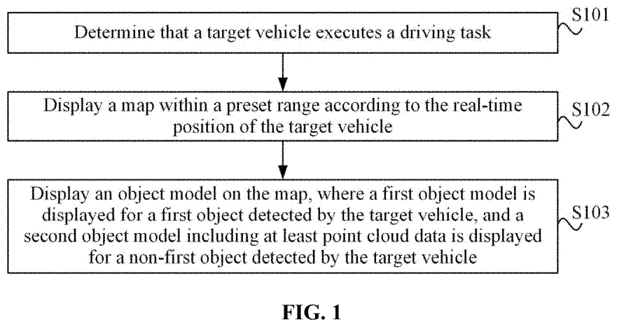

FIG. 1 is a flowchart of a visual interface display method according to some embodiments of the present application. Some embodiments are applicable to the case where a driving environment is displayed on a visual interface. This method may be executed by a visual interface display apparatus. The display apparatus may be performed by software and/or hardware and may be configured in an electronic device according to some embodiments of the present application. This method includes the steps below.

In S101, it is determined that a target vehicle executes a driving task.

The target vehicle may be a self-driving vehicle. The self-driving vehicle (also known as a driverless car, a self-driving car, or a robotic car) can sense an environment and navigate without human input. The self-driving vehicle may be equipped with a high-precision GPS navigation system and a laser radar configured to detect an obstacle. The self-driving vehicle may also be configured to sense its surrounding environment by using techniques such as a camera, a radar, light detection and ranging (LIDAR), the GPS, and other sensors and display the surrounding environment on a visual interface.

When the self-driving vehicle is in a self-driving mode, a self-driving program module may control devices such as a steering wheel, an accelerator, and a brake of the self-driving vehicle, so that self driving of the self-driving vehicle can be implemented without human intervention.

In some embodiments of the present application, it may be determined whether the target vehicle executes the driving task. When it is determined that the target vehicle executes the driving task, the task information of the driving task may be then acquired. The task information may include start point information and end point information of the driving of the target vehicle and may also include information such as the path planning strategy of the target vehicle from a start point to an end point and the display content of the visual interface. The start point information may be the coordinate of the start point and the end point information may be the coordinate of the end point. The path planning strategy may be a strategy such as a strategy with a shortest time, a strategy with a shortest path, or a strategy with a lowest cost. The display content of the visual interface may be the to-be-displayed content customized by a user. For example, the display content of the visual interface may include a task progress bar, a driven time, a map display mode, and a driving speed.

After the task information is acquired, a global map including the start point and the end point may be acquired through the information of the start point and the information of the end point. The global map is displayed according to the map display mode. The driving path from the start point to the end point is planned according to the path planning strategy. The driving path is displayed on the map. At the same time, other to-be-displayed contents are displayed on the visual interface.

In S102, a map within a preset range is displayed according to the real-time position of the target vehicle.

In some embodiments of the present application, the map may be a three-dimensional electronic map pre-generated according to a semantic map, where the map includes the model of a fixed object such as a building, a road surface, and a tree. When it is determined that the target vehicle executes the driving task, the real-time position of the target vehicle may be acquired by a positioning system mounted on the target vehicle. Optionally, the real-time position of the target vehicle may be acquired by the GPS. Alternatively, after the laser radar on the target vehicle scans the surrounding environment to obtain point cloud data, the real-time position of the target vehicle is determined according to the match result of the point cloud data and a pre-generated point cloud map. Alternatively, the real-time position of the target vehicle is acquired by other positioning sensors. The method of acquiring the real-time position of the target vehicle is not limited in some embodiments of the present application.

After the real-time position of the target vehicle is acquired, a map including the real-time position and within a preset range may be extracted from an electronic map database according to the real-time position and displayed on the visual interface. Optionally, the preset range may be a circular range of a preset radius centered on the real-time position of the target vehicle and may also be a preset sector range in front of the target vehicle centered on the real-time position of the target vehicle.

In S103, an object model is displayed on the map. A first object model is displayed for a first object detected by the target vehicle. A second object model including at least point cloud data is displayed for a non-first object detected by the target vehicle.

In some embodiments of the present application, after the target vehicle acquires the point cloud data of the surrounding environment by the laser radar, the point cloud data is input into a pre-trained classification model to obtain the classification result of each object in the point cloud data. The first object may be an object in which the classification result is a vehicle, the non-first object may be an object in which the classification result is other than a vehicle and/or an object without a classification result. In practical applications, the first object may also be an object that can be accurately classified by the classification model but is not limited only to a vehicle. For example, when there are other vehicles, pedestrians, bicycles, bicyclists, and traffic cones around the target vehicle, the classification model can give clear classification results for the classification models of the vehicles, pedestrians, bicycles, and traffic cones. However, it is not determined whether the classification of the bicyclists belongs to the bicycles or to the pedestrians. Moreover, on the visual interface, other vehicles around the target vehicle have more reference significance for self driving. On the visual interface, a vehicle may be used as the first object, and the first object model that can reflect the size of the vehicle is displayed. For the non-first object, the second object model may be displayed on the visual interface to indicate that the target vehicle detects the non-first object.

The first object model may be the three-dimensional model of another vehicle detected by the target vehicle. The three-dimensional model may be the solid model of another vehicle. Optionally, the first object model is a frame model, the frame model may be a three-dimensional rectangular frame, and the second object model may be a point cloud model. That is, for the first object, the three-dimensional rectangular box matching the first object is displayed on the map, and for the non-first object, the point cloud data of the non-first object is displayed on the map. The second object model may also be a model including at least the point cloud data, that is, the second object model may be a hybrid model of the point cloud model and a solid model. Since the non-first object is presented on the map directly in a point cloud form or at least partially in the point cloud form, it is not necessary to simulate the model of the non-first object according to data, that is, the data volume of model rendering of the non-first object is reduced, and it is not even necessary to render a model for the non-first object. In this manner, the speed of model rendering is improved.

In some embodiments of the present application, when the target vehicle executes the driving task, the first object model is displayed for the first object detected by the target vehicle on the map, and the second object model is displayed for the non-first object detected by the target vehicle. In this manner, the problem that the classification model is inaccurate in classifying the non-first object or unable to classify the non-first object, resulting in the display of a wrong model or even no model for the non-first object on the visual interface is solved. Thus, the first object model can be displayed for the accurately classified first object detected by the target vehicle, and the second object model including at least the point cloud data can be displayed for the inaccurately classified or unclassifiable non-first object detected by the target vehicle. Accordingly, models may be displayed for the first object and the non-first object detected by the target vehicle, and the second object model including at least the point cloud data may be displayed for the non-first object without classifying the non-first object. In this manner, the data volume of the model rendering of the non-first object is reduced, and it is not even necessary to render the model for the non-first object, so that while a model is displayed for a detected object, the speed of the model rendering is improved. Thus, the user experience is improved.

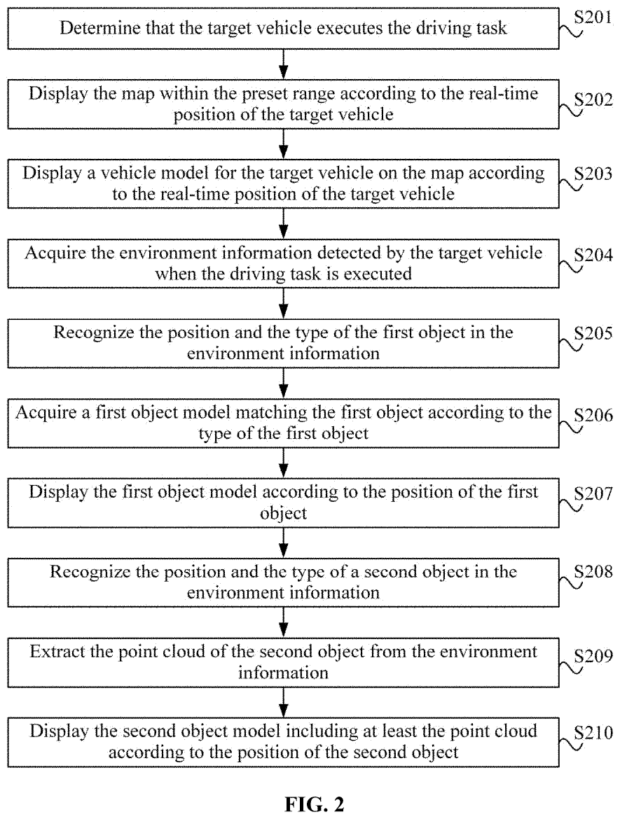

FIG. 2 is a flowchart of a visual interface display method according to some embodiments of the present application. Some embodiments are an optimization on the basis of the preceding embodiments. This method includes the steps below.

In S201, it is determined that the target vehicle executes the driving task.

In some embodiments of the present application, when the display request of the visual interface is received, it is determined that the target vehicle executes the driving task. Specifically, the target vehicle may be the self-driving vehicle. The driving task list may be established for the vehicle. The driving task list stores the time when the vehicle executes each driving task. When the display request of the visual interface is received, it is determined whether there is a driving task executed at the current time in the driving task list. If so, the task information of the driving task is then acquired. The task information is pre-configured and pre-stored information. For example, the task information may include start point information and end point information of the driving of the target vehicle and may further include information such as the path planning strategy of the target vehicle from a start point to an end point and the display content of the visual interface.

In S202, the map within the preset range is displayed according to the real-time position of the target vehicle.

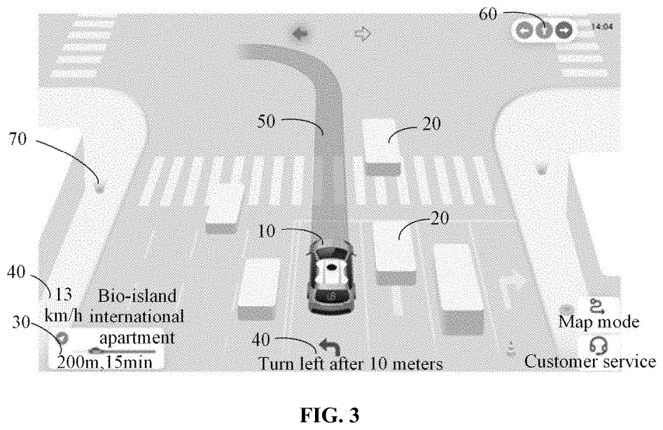

A map display mode option or a map display mode switch button may be provided on the visual interface. The map display mode may include a global mode and a local mode. The global mode is a mode that displays a map including a start point and an end point of the target vehicle. The local mode is a mode that displays a map within the preset range of the current position of the target vehicle. Of course, the map display mode may also be a 3D display mode or a 2D display mode, that is, a three-dimensional map or a two-dimensional map is displayed. The map display mode may also be a display mode from a third viewing angle or a display mode from a driver's viewing angle. The driver's viewing angle is an angle viewed from a driver's seat. The third viewing angle may be a viewing angle other than the target vehicle. FIG. 3 shows the map viewed from the third viewing angle.

In some embodiments of the present application, the map may be the three-dimensional electronic map including the model of a fixed object, such as a building, a road surface, and a tree, pre-generated according to the semantic map. When the user selects to display a 3D local map, the map within a preset range may be determined according to the real-time position of the target vehicle. The map within the preset range may be displayed on the visual interface at a viewing angle selected by the user. The preset range may be a circular range of a preset radius centered on the real-time position of the target vehicle or may be a preset sector range in front of the target vehicle centered on the real-time position of the target vehicle.

In S203, a vehicle model is displayed for the target vehicle on the map according to the real-time position of the target vehicle.

In some embodiments of the present application, the vehicle model may be pre-configured for the target vehicle. The vehicle model may be the three-dimensional model of the target vehicle or the frame model of the target vehicle. After the map within the preset range is displayed according to the real-time position of the target vehicle, the vehicle model of the target vehicle may be displayed at the real-time position of the target vehicle on the map. For example, as shown in FIG. 3, the vehicle model 10 of the target vehicle may be displayed at the real-time position of the target vehicle on the map.

In S204, the environment information detected by the target vehicle is acquired when the driving task is executed.

Specifically, a sensor such as a laser radar, a millimeter wave radar, a camera, and an infrared sensor may be mounted on the target vehicle. During driving, the target vehicle may detect the surrounding environment of the target vehicle through at least one of the preceding sensors to obtain multiple sensor data and use the multiple sensor data as the environment information. For example, at least one laser radar is mounted on the target vehicle. When the target vehicle executes the driving task, the laser radar mounted on the target vehicle emits a laser signal. The laser signal is diffusely reflected by various objects in the scenario around the target vehicle and returned to the laser radar. The laser radar obtains point cloud data and uses the point cloud data as the environment information after performing processing, such as noise reduction and sampling, on the received laser signal.

The target vehicle may also capture an image according to a preset period by a camera. A distance from each object in the image to the target vehicle is further computed according to the captured image in combination with an image ranging algorithm and used as the environment information. Alternatively, semantic segmentation is performed on the image to obtain semantic information in the image, and the semantic information is used as the environment information. For example, the semantic segmentation is performed on the image to obtain a semantic segmentation area such as a traffic light, a vehicle, and a pedestrian, and the semantic segmentation area is used as the environment information. The camera may be one of a monocular camera, a binocular camera, and a multi-ocular camera.

In S205, the position and the type of the first object in the environment information are recognized.

In some embodiments of the present application, the environment information may include a point cloud data obtained by a sensor. The classification model may be pre-trained to classify various objects that form the point cloud data. For example, the point cloud data of the various objects may be acquired, and the classification to which an object belongs is marked and used as training data to train the classification model. The trained classification model may recognize the classification to which each object belongs from the point cloud data after inputting the point cloud data.

Of course, the environment information may also be an image captured by a camera. The images of various objects may be acquired. The classification to which an object belongs is marked and used as the training data to train the classification model. The trained classification model may recognize the classification to which each object belongs from the image after inputting the image. Alternatively, the environment information may be the radar data of a millimeter wave radar. The classification model may be trained by using the radar data. Optionally, environment information data may include multiple sensor data such as point cloud data, an image, and radar data. The classification model may be trained by using the multiple sensor data. Some embodiments of the present application do not limit what type of data is used to train the classification model.

In some embodiments of the present application, the object may be an object around the target vehicle. For example, the object may be other vehicles, pedestrians, bicycles, traffic lights, and traffic cones around the target vehicle. Optionally, the first object may be a vehicle. When the environment information is point cloud data, the point cloud data may be input into the pre-trained classification model to recognize an object whose type is a vehicle and use the object as the first object. At the same time, the position of the first object in the point cloud data may be obtained by point cloud registration. This position may be the position of the first object relative to the target vehicle or the position of the first object in the world coordinate system. There may be one or more first objects, that is, all vehicles around the target vehicle are recognized from the point cloud data, and the position of each vehicle is determined.

In S206, the first object model matching the first object is acquired according to the type of the first object.

In some embodiments of the present application, the first object model may be pre-configured for the first object. The first object model may be the three-dimensional model of the first object or may be a frame model representing the outline size of the first object. As shown in FIG. 3, the first object model is the frame model 20. In practical applications, the outline size of the first object may be determined through the point cloud data. For example, the length, width, and height size of the first object may be determined. Then a frame model of a matched size may be searched from a frame model library according to the length, width, and height size of the first object and used as the first object model of the first object, so that first object models of matched sizes may be displayed for first objects of different sizes. Further, the first object may be divided into a large vehicle and a small vehicle according to the outline size. The large vehicle may include a truck, a bus, or other large-sized engineering vehicles. The small vehicle may include a small passenger van and a van. Thus, the vehicle type to which the first object model belongs may be determined according to the outline size of the first object. In this manner, the user may know vehicle types around the target vehicle to determine whether to perform human intervention or not. For example, when there is a road condition where many trucks are in a port or an industrial area, the user may know from the visual interface that the target vehicle is driving in the road condition where there are many trucks to determine whether to switch from the self-driving mode to a remote control driving mode.

In some embodiments of the present application, the environment information detected by the sensor on the target vehicle may be input into a pre-trained detection model. The classification result, position, outline size, orientation, speed, and acceleration of each object are obtained by the detection model. When the classification result of an object is a vehicle, the object is the first object. The outline size data of the first object is input into a renderer to render a frame model, and the frame model is used as the first object model. The frame model is rendered through the outline size. In this manner, the data volume is small, and the model is simple, so that the speed of acquiring the first object model can be improved.

In S207, the first object model is displayed according to the position of the first object.

Specifically, the first object model is displayed at the position where the first object is located on the map so that the vehicle model of the target vehicle and the first object model of the first object around the vehicle model are displayed on the visual interface. Exemplarily, after the orientation of the first object model is determined, for example, the orientation of the head of a vehicle is determined, the first object model may be displayed at the position where the first object is located according to the orientation, that is, the orientation of the head of the vehicle may be reflected from the first object model. In this manner, it is possible to clearly know on the visual interface whether the vehicle is driving in the same direction or in the opposite direction. Specifically, the shape feature or mark of the head of the vehicle may be added to the end where the head is located in the frame model, and the shape feature or mark of the tail of the vehicle may be added to the end where the tail is located in the frame model. As shown in FIG. 3, the vehicle model 10 of the target vehicle and the first object model 20 of the first object around the vehicle model 10 are displayed on the map.

In S208, the position and the type of a second object in the environment information are recognized.

In some embodiments of the present application, the second object may be an object other than the first object. Optionally, the first object is a vehicle, and the second object is a pedestrian, a bicycle, a telegraph pole, and a traffic cone other than the vehicle. The environment information may include point cloud data. The point cloud data may be input into the pre-trained classification model to recognize an object whose type is not the type to which the first object belongs or that cannot be classified. The object whose type is not the type to which the first object belongs or that cannot be classified is used as the second object, that is, the non-first object. The position of the second object in the point cloud data may be obtained by point cloud registration. Of course, the environment information may also include an image captured by a camera and a scan data of a millimeter wave radar. The environment information may be input into the pre-trained detection model to obtain classification results and positions of various objects. An object classified differently from the first object may be used as the second object.

In S209, the point cloud data of the second object is extracted from the environment information.

In some embodiments of the present application, the environment information includes the point cloud data obtained by the laser radar and the image captured by the camera. The second object in the image may be recognized by a target detection algorithm. After the camera and the laser radar are jointly calibrated, the second object recognized in the image is projected into the point cloud data, so that the point cloud data of the second object may be separated from the point cloud data obtained by the laser radar.

In some embodiments of the present application, the sensor (a camera, a laser radar, or a millimeter wave radar) on the target vehicle acquires multiple frames of environment information according to a preset period. The environment information acquired in each period is stored into a queue in a time sequence. Each frame of environment information is read from the queue and input into the classification model to recognize at least one second object from each frame of environment information. The point cloud data of all second objects are extracted from a frame of environment information. Then the point cloud data of all the second objects are input into a pre-trained point cloud separation model to separate the point cloud data of each second object. The point cloud data of each second object obtained from the multiple frames of environment information is smoothed. The smoothed point cloud data is used as the final point cloud data of a second object. The point cloud data of multiple second objects may be acquired to train the point cloud separation model so that the point cloud separation model may separate the point cloud data of each object from the point cloud data of multiple objects.

In some embodiments of the present application, smoothing processing performed on a point cloud may include point cloud preprocessing and point cloud smoothing. The point cloud preprocessing may include removing outliers, removing noise points, and removing distortion points. The smoothing processing may include average filter smoothing. Specifically, for each point in the point cloud data of each second object, the average value of the point in the point cloud data of each second object obtained from the multiple frames of environment information may be computed. For example, the average value of the three-dimensional coordinates of a certain point in the point cloud data of each second object obtained from two adjacent frames or more than two frames of environment information is computed and used as the result of smoothing processing. Of course, smoothing processing may also be median filter smoothing and Gaussian filter smoothing. The smoothing processing method of point cloud data is not limited in some embodiments of the present application.

In some embodiments of the present application, the point cloud data of the second object is preprocessed to remove an invalid point and a noise point, thereby improving the accuracy of the point cloud data. Further, the point cloud data of the second object is smoothed to obtain the smoothed point cloud data of the second object. When the point cloud data of the second object is displayed, a good display effect can be obtained on the visual interface.

In S210, the second object model including at least the point cloud data is displayed according to the position of the second object.

In some embodiments of the present application, the second object model may be the point cloud model, that is, the point cloud model of the second object is displayed directly at the position where the second object is located on the map. As shown in FIG. 3, the point cloud model 70 is shown in FIG. 3. In some embodiments of the present application, there is no need to explicitly classify the second object, nor to match a model for the second object, thereby improving the display efficiency of the model of the second object.

In some embodiments of the present application, a display template pre-configured for the second object may be acquired. The display template may include the modification model of a solid. The point cloud data of the second object is displayed on the modification model. The point cloud data of the second object is displayed on the modification model as follows: The point cloud data of the second object is scaled so that the projection contour of the point cloud data of the second object on the ground is surrounded by the projection contour of the modification model. For example, the modification model is a disk, and the second object is a traffic cone. The point cloud data corresponding to the traffic cone may be scaled to display the scaled point cloud data on the disk.

In another example, the point cloud of the second object is displayed on the modification model as follows: The outline contour size of the point cloud is computed; the size of the modification model is adjusted according to the outline contour size; and the point cloud is displayed in the adjusted modification model. For example, the modification model may be a cylindrical space. The bottom of the cylindrical space is solid. The upper space of the cylindrical space is transparent. The diameter of the cylindrical space may be adjusted according to the projection contour of the point cloud on the ground, and the height of the cylindrical space may be adjusted according to the height of the point cloud, so that the point cloud may be accommodated in the cylindrical space. For example, the point cloud of a pedestrian may be displayed on the solid of the bottom of the cylindrical space, so that the outline size of the pedestrian may be known from the visual interface according to the contour of the cylindrical space.

In some embodiments of the present application, when the target vehicle executes the driving task, the map within the preset range is displayed according to the real-time position of the target vehicle, and the vehicle model of the target vehicle is displayed on map. After the environment information is acquired, the position and type of the first object are recognized from the environment information. The first object model is matched according to the type of the first object and displayed on the map. The position and type of the second object are recognized from the environment information. The point cloud of the second object is extracted. The second object model including the point cloud of the second object is displayed on the map. In this manner, the problem that the classification model is inaccurate in classifying the non-first object or unable to classify the non-first object, resulting in the display of a wrong model or even no model for the non-first object on the visual interface is solved. Thus, the first object model can be displayed for the accurately classified first object detected by the target vehicle, and the second object model including the point cloud can be displayed for the inaccurately classified or unclassifiable second object detected by the target vehicle. Accordingly, models may be displayed for the first object and the second object detected by the target vehicle, and the second object model including at least the point cloud may be displayed for the non-first object without classifying the second object. In this manner, the data volume of the model rendering of the non-first object is reduced, and it is not even necessary to render the model for the non-first object. Thus, the speed of the model rendering is improved, and the user experience is improved.

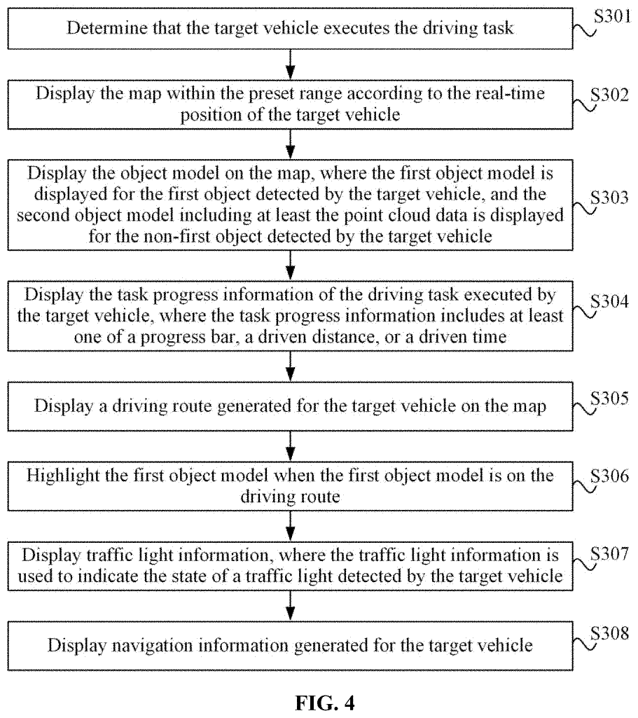

FIG. 4 is a flowchart of a visual interface display method according to some embodiments of the present application. Some embodiments are an optimization on the basis of the preceding embodiments. This method includes the steps below.

In S301, it is determined that the target vehicle executes the driving task.

In S302, the map within the preset range is displayed according to the real-time position of the target vehicle.

In S303, the object model is displayed on the map. The first object model is displayed for the first object detected by the target vehicle. The second object model including at least the point cloud data is displayed for the non-first object detected by the target vehicle.

In S304, the task progress information of the driving task executed by the target vehicle is displayed. The task progress information includes at least one of a progress bar, a driven distance, or a driven time.

In some embodiments of the present application, the task progress information may be the progress information of the driving task executed by the target vehicle. The task progress information may be at least one of a progress bar, a driven distance, or a driven time. The progress bar may be generated according to the driven distance and a total distance. The driven distance may be counted by an odometer on the target vehicle.

As shown in FIG. 3, the task progress information 30 is displayed on the visual interface. The task progress information 30 may include a progress bar. The progress bar indicates the execution progress of the driving task. The task progress information 30 may also include a driven distance, that is, a driven distance after the target vehicle starts to execute the driving task. The task progress information 30 may also include a driven time, that is, a total driven time after the target vehicle starts to execute the driving task. Of course, the task progress information may be indicated in other forms such as a percentage. The display method of the task progress information is not limited in some embodiments of the present application.

In S305, a driving route generated for the target vehicle is displayed on the map.

Specifically, the driving task may be a task in which the target vehicle drives from a specified start point to a specified end point. After the start point and the end point are determined, the driving route is planned in real time in combination with the environment information detected by the sensor on the target vehicle, and the driving route is displayed on the map. For example, the driving route from the start point to the end point is planned after the start point and the end point are determined. During real-time driving, the lane on which the target vehicle drives during driving is planned in real time according to the environment information detected by the sensor. As shown in FIG. 3, the driving route 50 may be displayed in the form of a light band in the driving direction of the target vehicle, so that the driving route 50 is distinctly distinguished from a road marker line such as a zebra crossing and a lane line in the map, thereby facilitating the user to distinguish the driving route in the map.

In S306, the first object model is highlighted when the first object model is on the driving route.

In some embodiments of the present application, the first object may be a vehicle detected by the target vehicle. It may be determined whether or not to highlight the first object model of the first object according to the interference degree of the first object to the driving of the target vehicle.

In some embodiments of the present application, when the target vehicle drives in a straight line, the vehicle detected by the target vehicle may be a vehicle around the target vehicle, and the interference degree may be a vehicle detected within a preset range around the target vehicle. Optionally, the target vehicle detects a vehicle in a circular area of a preset radius centered on the target vehicle and obtains distances between all vehicles in the circular area and the target vehicle. When the distances are less than a preset threshold, it is determined that the vehicles are interference vehicles. Models of the interference vehicles in the circular area may be highlighted, that is, the first object model is highlighted. For example, when the target vehicle drives in a straight line, a vehicle in front of the target vehicle brakes suddenly, or the driving speed drops, and as a result, the distance between the front vehicle and the target vehicle is decreased. When the distance is less than the preset threshold, it indicates that the front vehicle is on the driving route on which the target vehicle needs to drive, and the distance is less than the preset threshold. The first object model of the front vehicle on the driving route may be highlighted to alert the user that the vehicle interferes with the driving of the target vehicle.

For another example, when the target vehicle drives in a straight line, a nearby vehicle of the target vehicle approaches the target vehicle by changing a lane. When the distance between the nearby vehicle and the target vehicle is less than the preset threshold, if the target vehicle still drives in the current direction, a collision may occur. The first object model of the nearby vehicle of the target vehicle may be highlighted to alert that the nearby vehicle interferes with the normal driving of the target vehicle. In some embodiments of the present application, an interference vehicle in the circular area of the preset radius centered on the target vehicle can be highlighted to facilitate the user to perform timely human supervision or human intervention, thereby improving the driving safety of the target vehicle.

In some embodiments of the present application, when the target vehicle changes a lane, the distance from a vehicle around the target vehicle to the target vehicle may be computed. If the distance is less than the preset threshold, the first object model of the vehicle whose distance from the target vehicle is less than the preset threshold among the surrounding vehicles is highlighted to alert that the surrounding vehicle interferes with the lane change of the target vehicle. In this manner, the user performs timely human supervision or human intervention, thereby improving the driving safety of the target vehicle.

Further, the brightness of the highlighted first object model may be determined according to the magnitude of the interference degree. For example, a highlighted color may be gradually changed according to a distance. For example, the highlighted color is red. The smaller the distance is, the darker the red color is, and vice versa. Thus, the user may know the interference degree of a surrounding vehicle to the target vehicle according to the brightness of the highlighted color.

In S307, traffic light information is displayed. The traffic light information is used to indicate the state of a traffic light detected by the target vehicle.

Specifically, a camera is mounted on the target vehicle. The camera captures a traffic light at an intersection through which the target vehicle needs to pass to obtain an image. Image recognition is performed on the image to acquire the state of the traffic light. The state of the traffic light is displayed in a virtual traffic light of the visual interface. As shown in FIG. 3, the traffic light information 60 may be displayed in the upper right corner of the visual interface.

In some embodiments of the present application, if the camera captures multiple traffic lights, for example, when multiple traffic lights are captured at an intersection, a target traffic light may be determined from the multiple traffic lights according to the real-time position and the driving route of the target vehicle, and the state of the target traffic light is displayed. For example, when the driving travel path of the target vehicle is to continue driving in a straight line from the current position, a traffic light in front of the target vehicle is used as the target traffic light. The state of the traffic light is recognized and displayed on the visual interface. Alternatively, when the next driving path of the target vehicle is steering driving, a traffic light in the steering direction of the target vehicle is used as the target traffic light. The state of the traffic light is recognized and displayed on the visual interface. In some embodiments of the present application, the target traffic light is determined from multiple traffic lights. In this manner, the state of the multiple traffic lights may be prevented from being recognized, and the data volume of image recognition is reduced. Moreover, not only the display speed of the traffic light information is improved, but also the number of traffic lights displayed on the visual interface is reduced, thereby making the visual interface more concise.

In some embodiments of the present application, the state of a pedestrian traffic light may be determined first. The state of a traffic light in front of the target vehicle is determined according to the state of the pedestrian traffic light. Specifically, when a zebra crossing is detected in the driving direction of the target vehicle from the map, pedestrian traffic lights at two ends of the zebra crossing are determined, and the images of the pedestrian traffic lights are acquired. The images are recognized to obtain the states of pedestrian traffic lights. The state of the traffic light, in front of the target vehicle, for instructing the driving of the target vehicle is determined according to the states of the pedestrian traffic lights. For example, when a pedestrian traffic light is green, it is determined that the state of the traffic light, in front of the target vehicle, for instructing the driving of the target vehicle is red; and when the pedestrian traffic light is red, it is determined that the state of the traffic light, in front of the target vehicle, for instructing the driving of the target vehicle is green. Accordingly, the traffic light information may be displayed in advance. Alternatively, when a front vehicle blocks a front traffic light, and as a result, the camera cannot obtain the image of the front traffic light, the information of the front traffic light is determined according to the information of a nearby pedestrian traffic light.

In S308, navigation information generated for the target vehicle is displayed.

In some embodiments of the present application, the navigation information may be the driving speed of the target vehicle, the distance from the target vehicle to a destination, steering reminder information of the driving route, and vehicle lane change reminder information in a driving process. The navigation information may be displayed on the visual interface. The steering reminder information may be the display of a steering mark and the display of the distance from the target vehicle to a steering position on the visual interface. The driving speed may be words or a virtual speedometer displayed on the visual interface. The vehicle lane change reminder information may be broadcast in a voice manner through a speaker. As shown in FIG. 3, the navigation information 40 is the steering reminder information of the driving route and the driving speed of the target vehicle.

In some embodiments of the present application, the sensor on the target vehicle may also sense the light intensity of the surrounding environment. The display mode of the visual interface is adjusted according to the light intensity. The map display mode may include a night mode or a day mode. Of course, it is also possible to determine whether it is day or night according to the current time. In this manner, the display mode is switched between the night mode and the day mode, so that the visual interface can be displayed according to the light intensity of the environment, thereby improving the comfort of human eye viewing.

In some embodiments of the present application, when the target vehicle executes the driving task, the first object model is displayed for the first object detected by the target vehicle on the map, and the second object model including at least the point cloud data is displayed for the non-first object detected by the target vehicle. In this manner, the problem that the classification model is inaccurate in classifying the non-first object or unable to classify the non-first object, resulting in the display of a wrong model or even no model for the non-first object on the visual interface is solved. Thus, the first object model is displayed for the accurately classified first object detected by the target vehicle, and the second object model can be displayed for the inaccurately classified or unclassifiable non-first object detected by the target vehicle. Accordingly, the models may be displayed for the first object and the non-first object detected by the target vehicle, and the second object model including at least the point cloud may be displayed for the non-first object without classifying the non-first object. In this manner, the data volume of the model rendering of the non-first object is reduced, and it is not even necessary to render a model for the non-first object, so that while a model is displayed for a detected object, the speed of the model rendering is improved. Thus, the user experience is improved.

Further, the driving route, the traffic light information, and the navigation information are displayed for the target vehicle on the visual interface, so that the visualization of driving data is implemented.

Furthermore, when the first object detected in the preset range interferes with the driving of the target vehicle, the first object model of the first object is highlighted to alert the user that the first object blocks the driving of the target vehicle. In this manner, the user performs timely human supervision or human intervention, thereby improving the driving safety of the target vehicle.

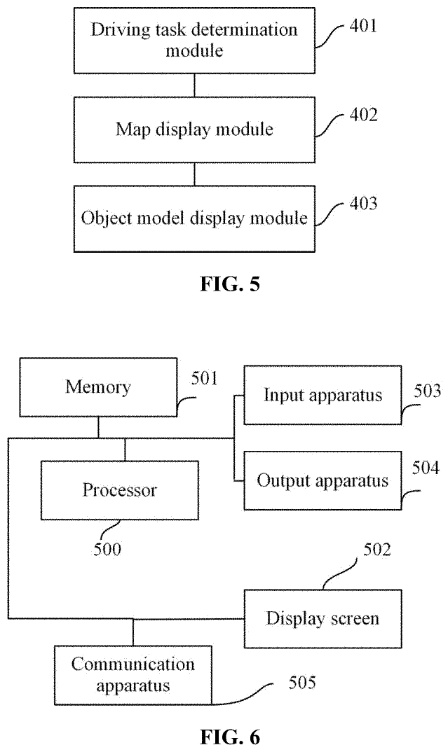

FIG. 5 is a diagram illustrating the structure of a visual interface display apparatus according to some embodiments of the present application. This apparatus may include the modules below.

A driving task determination module 401 is configured to determine that the target vehicle executes the driving task. A map display module 402 is configured to display the map within the preset range according to the real-time position of the target vehicle. An object model display module 403 is configured to display the object model on the map. The first object model is displayed for the first object detected by the target vehicle. The second object model including at least the point cloud data is displayed for the non-first object detected by the target vehicle.

Optionally, the apparatus also includes a vehicle model display module.

The vehicle model display module is configured to display the vehicle model for the target vehicle on the map according to the real-time position of the target vehicle.

Optionally, the object model display module 403 includes a point cloud acquisition sub-module, a first object recognition sub-module, a first object model matching sub-module, and a first object model display sub-module.

The point cloud acquisition sub-module is configured to acquire the environment information detected by the target vehicle when the driving task is executed. The first object recognition sub-module is configured to recognize the position and the type of the first object in the environment information. The first object model matching sub-module is configured to acquire the first object model matching the first object according to the type of the first object. The first object model display sub-module is configured to display the first object model according to the position of the first object.

Optionally, the object model display module 403 includes a point cloud acquisition sub-module, a second object recognition sub-module, a point cloud extraction sub-module, and a second object model display sub-module.

The point cloud acquisition sub-module is configured to acquire the environment information detected by the target vehicle when the driving task is executed. The second object recognition sub-module is configured to recognize the position and the type of the second object in the environment information. The point cloud extraction sub-module is configured to extract the point cloud of the second object from the environment information. The second object model display sub-module is configured to display the second object model including at least the point cloud according to the position of the second object.

Optionally, the apparatus also includes a task progress information display module.

The task progress information display module is configured to display the task progress information of the driving task executed by the target vehicle. The task progress information includes at least one of a progress bar, a driven distance, or a driven time.

Optionally, the apparatus also includes an information display module, and/or a traffic light information display module, and/or a navigation information display module.

The information display module is configured to display the driving route generated for the target vehicle on the map. Moreover/Alternatively, the traffic light information display module is configured to display the traffic light information. The traffic light information is used to indicate the state of the traffic light detected by the target vehicle. Moreover/Alternatively, the navigation information display module is configured to display the navigation information generated for the target vehicle.

Optionally, the apparatus also includes a highlight display module.

The highlight display module is configured to highlight the first object model when the first object model is on the driving route.

Optionally, the navigation information display module includes a speed display sub-module and a distance display sub-module.

The speed display sub-module is configured to display the speed of the target vehicle when the target vehicle executes the driving task. The distance display sub-module is configured to display the distance from the target vehicle to the destination.

The visual interface display apparatus provided in some embodiments of the present application may execute the visual interface display method provided in any embodiment of the present application and has functional modules and beneficial effects corresponding to the method executed.

Referring to FIG. 6, a diagram illustrating the structure of an electronic device according to an example of the present application is shown. As shown in FIG. 6, the device may include a processor 500, a memory 501, a display screen 502 having a touch function, an input apparatus 503, an output apparatus 504, and a communication apparatus 505. The number of processors 500 in the device may be one or more. A description is given with reference to FIG. 6 by using an example in which there is one processor 500. The number of memories 501 in the device may be one or more. A description is given with reference to FIG. 6 by using an example in which there is one memory 501. The processor 500, the memory 501, the display screen 502, the input apparatus 503, and the output apparatus 504 in the device may be connected via a bus or in other manner, where the connection via a bus is shown as an example in FIG. 6.

The memory 501 as a computer-readable storage medium is configured to store a software program, a computer-executable program, and modules, for example, program instructions/modules corresponding to the visual interface display method provided in any embodiment of the present application (for example, the driving task determination module 401, the map display module 402, and the object model display module 403 in the preceding visual interface display apparatus). The memory 501 may mainly include a program storage area and a data storage area. The program storage area may store an operating apparatus and an application program required by at least one function, and the data storage area may store the data created depending on use of the device. Additionally, the memory 501 may include a high speed random access memory and may also include a non-volatile memory, for example, at least one disk memory element, flash memory element or another non-volatile solid-state memory element. In some examples, the memory 501 may further include memories located remotely relative to the processor 500 and these remote memories may be connected to the device via networks. Examples of the preceding network include, but are not limited to, the Internet, an intranet, a local area network, a mobile communication network and a combination thereof.

The display screen 502 is a display screen 502 having a touch function and may be a capacitance screen, an electromagnetic screen, or an infrared screen. In general, the display screen 502 is configured to display data according to the instructions of the processor 500, also configured to receive a touch operation acting on the display screen 502, and configured to send a corresponding signal to the processor 500 or other devices. Optionally, when the display screen 502 is the infrared screen, the display screen 502 also includes an infrared touch frame disposed around the display screen 502. The display screen 502 may also be configured to receive an infrared signal and send the infrared signal to the processor 500 or other devices.

The communication apparatus 505 is configured to establish a communication connection to other devices and may be a wired communication apparatus and/or a wireless communication apparatus.

The input apparatus 503 may be configured to receive inputted digital or character information and to generate key signal input related to user configuration and function control of the device. The output apparatus 504 may include an audio device such as a speaker. It is to be noted that the specific composition of the input apparatus 503 and the output apparatus 504 may be set according to actual situations.

The processor 500 executes software programs, instructions, and modules stored in the memory 501 to perform various functional applications and data processing of the device, that is, to implement the preceding visual interface display method.

Specifically, in some embodiments, when executing one or more programs stored in the memory 501, the processor 500 performs steps of the visual interface display method according to some embodiments of the present application.

Some embodiments of the present application also provide a computer-readable storage medium. The storage medium stores a computer program. When executing the computer program, a processor may perform the visual interface display method according to any embodiment of the present application. The method includes the steps below.

It is determined that the target vehicle executes the driving task. The map within the preset range is displayed according to the real-time position of the target vehicle. The object model is displayed on the map. The first object model is displayed for the first object detected by the target vehicle. The second object model including at least the point cloud data is displayed for the non-first object detected by the target vehicle.

In the storage medium including computer-executable instructions provided by some embodiments of the present application, the computer-executable instructions may execute not only the preceding method operations but also related operations in the visual interface display method provided by any embodiment of the present application on the device.

It is to be noted that for the apparatus, electronic device, and storage medium embodiments, since they are substantially similar to the method embodiments, the description is relatively simple, and for a related part, reference may be made to the description of the related part in the method embodiments.

From the preceding description of embodiments, the present application may be implemented by means of software and necessary general-purpose hardware, or may be implemented by hardware. The solutions provided by the present application may be embodied in the form of a software product. The software product may be stored in a computer-readable storage medium, such as a computer floppy disk, a read-only memory (ROM), a random access memory (RAM), a flash, a hard disk or an optical disk, and includes several instructions for enabling a computer device (which may be a personal computer, a server or a network device) to execute the visual interface display method of each embodiment of the present application.

It is to be noted that each unit and module included in some embodiments of the visual interface display apparatus are just divided according to functional logic but are not limited to such division, as long as the corresponding functions can be implemented. In addition, the specific names of the functional units are just used for distinguishing between each other and are not intended to limit the scope of the present application.

1. A visual interface display method, comprising:
determining that a target vehicle executes a driving task;
displaying a map within a preset range according to a real-time position of the target vehicle; and
displaying an object model on the map which comprises displaying a first object model for a first object detected by the target vehicle and displaying a second object model comprising at least point cloud data for a non-first object detected by the target vehicle.

2. The method according to claim 1, further comprising:
displaying a vehicle model for the target vehicle on the map according to the real-time position of the target vehicle.

3. The method according to claim 1, wherein displaying the first object model for the first object detected by the target vehicle comprising:
acquiring environment information detected by the target vehicle when the driving task is executed;
recognizing a position and a type of the first object in the environment information;
acquiring the first object model matching the first object according to the type of the first object; and
displaying the first object model according to the position of the first object.

4. The method according to claim 1, wherein displaying the second object model comprising at least the point cloud data for the non-first object detected by the target vehicle comprising:
acquiring environment information detected by the target vehicle when the driving task is executed;
recognizing a position and a type of a second object in the environment information;
extracting point cloud data of the second object from the environment information; and
the second object model comprising at least the point cloud data is displayed according to the position of the second object.

5. The method according to claim 1, further comprising:
displaying task progress information of the driving task executed by the target vehicle, wherein the task progress information comprises at least one of a progress bar, a driven distance, or a driven time.

6. The method according to claim 1, further comprising at least one of:
displaying a driving route generated for the target vehicle on the map;
displaying traffic light information, wherein the traffic light information is used to indicate a state of a traffic light detected by the target vehicle; or
displaying navigation information generated for the target vehicle.

7. The method according to claim 6, further comprising:
highlighting the first object model when the first object model is on the driving route.

8. The method according to claim 6, wherein displaying the navigation information generated for the target vehicle comprises at least one of:
displaying a speed of the target vehicle when the target vehicle executes the driving task; or
displaying a distance from the target vehicle to a destination.

9. (canceled)

10. An electronic device, comprising:
one or more processors, and
a memory configured to store one or more programs,
wherein when executing the one or more programs, the one or more processors perform;
determining that a target vehicle executes a driving task;
displaying a map within a preset range according to a real-time position of the target vehicle; and
displaying an object model on the map which comprises displaying a first object model for a first object detected by the target vehicle and displaying a second object model comprising at least point cloud data for a non-first object detected by the target vehicle.

11. A non-transitory computer-readable storage medium storing a computer program, wherein when executing the computer program, a processor performs;
determining that a target vehicle executes a driving task;
displaying a map within a preset range according to a real-time position of the target vehicle; and
displaying an object model on the map which comprises displaying a first object model for a first object detected by the target vehicle and displaying a second object model comprising at least point cloud data for a non-first object detected by the target vehicle.

12. The method according to claim 2, further comprising:
displaying task progress information of the driving task executed by the target vehicle, wherein the task progress information comprises at least one of a progress bar, a driven distance, or a driven time.

13. The method according to claim 3, further comprising:
displaying task progress information of the driving task executed by the target vehicle, wherein the task progress information comprises at least one of a progress bar, a driven distance, or a driven time.

14. The method according to claim 4, further comprising:
displaying task progress information of the driving task executed by the target vehicle, wherein the task progress information comprises at least one of a progress bar, a driven distance, or a driven time.

15. The method according to claim 2, further comprising at least one of:
displaying a driving route generated for the target vehicle on the map;
displaying traffic light information, wherein the traffic light information is used to indicate a state of a traffic light detected by the target vehicle; or
displaying navigation information generated for the target vehicle.

16. The method according to claim 3, further comprising at least one of:
displaying a driving route generated for the target vehicle on the map;
displaying traffic light information, wherein the traffic light information is used to indicate a state of a traffic light detected by the target vehicle; or
displaying navigation information generated for the target vehicle.

17. The method according to claim 4, further comprising at least one of:
displaying a driving route generated for the target vehicle on the map;
displaying traffic light information, wherein the traffic light information is used to indicate a state of a traffic light detected by the target vehicle; or
displaying navigation information generated for the target vehicle.
